(19) United States
(12) Patent Application Publication
(10) Pub. No.: US 2017/0141904 A1
(43) Pub. Date: May 18, 2017

(54) METHOD AND APPARATUS FOR TRANSMITTING ACK/NACK

(71) Applicant: LG ELECTRONICS INC., Seoul (KR)

(72) Inventors: Joonkui AHN, Seoul (KR); Suckchel YANG, Seoul (KR); Yunjung YI, Seoul (KR)

(73) Assignee: LG ELECTRONICS INC., Seoul (KR)

(21) Appl. No.: 15/323,716

(22) PCT Filed: Jul. 2, 2015
(86) PCT No.: PCT/KR2015/006822

§ 371 Date: Jan. 3, 2017

Related U.S. Application Data
(60) Provisional application No. 62/091,632, filed on Dec. 15, 2014.
(60) Provisional application No. 62/021,014, filed on Jul. 4, 2014.
(60) Provisional application No. 62/108,054, filed on Jan. 26, 2015.

(51) Int. Cl. H04L 5/00; H04L 29/08; H04W 72/04; H04W 72/10

(52) U.S. Cl. CPC H04L 5/0055; H04W 72/10; H04L 69/324; H04W 72/0406

(57) ABSTRACT

Provided are a method and apparatus for transmitting an ACK/NACK in a wireless communication system. A first cell group and a second cell group are configured, wherein the first cell group comprises a primary cell capable of transmitting an uplink (UL) control channel, and the second cell group comprises a secondary cell capable of transmitting the UL control channel. The apparatus receives a plurality of downlink (DL) transmission blocks from a plurality of cells belonging to the first cell group and the second cell group, and generates an ACK/NACK payload according to a priority of a corresponding cell among a plurality of ACK/NACK bits corresponding to the plurality of DL transmission blocks.

### BACKGROUND OF THE INVENTION

Field of the invention

The present invention relates to wireless communications, and more particularly, to a method and apparatus for transmitting acknowledgement (ACK)/negative acknowledgement (NACK) in a wireless communication system.

Related Art

With the advancement of mobile technologies, a usage amount of data traffic is rapidly increased. In order for the data traffic to be processed much faster and with more amount by using a limited radio resource, a standardization task and a technology development are underway in several aspects. A representative example thereof may include three dimensional (3D) beam forming, massive multiple input multiple output (MIMO), a heterogeneous network, a small cell, or the like.

The small cell is used in one of techniques for increasing a traffic capacity and a data rate. In general, the small cell is disposed as a hotspot within coverage of a macro cell. A backhaul between the small cell and the macro cell may be ideal or non-ideal. A technique such as an intra-site carrier aggregation (CA) or a coordinated multi-point (CoMP) assumes an ideal backhaul. A dual connectivity is also called an inter-side CA, and assumes a non-ideal backhaul. The ideal backhaul does not almost consider a transmission delay between network nodes, whereas the transmission delay between the network nodes must be considered in a dual connectivity having a non-ideal backhaul.

Uplink transmission is proposed in an environment where a plurality of cells are configured.

### SUMMARY OF THE INVENTION

The present invention provides a method and apparatus for transmitting an ACK/NACK.

In an aspect, a method for transmitting an ACK/NACK in a wireless communication system is provided. The method includes configuring a first cell group and a second cell group, wherein the first cell group comprises a primary cell capable of transmitting an uplink (UL) control channel and the second cell group comprises a secondary cell capable of transmitting the UL control channel, receiving a plurality of downlink (DL) transport blocks from a plurality of cells belonging to the first cell group and the second cell group, generating an ACK/NACK payload according to a priority of a corresponding cell among a plurality of ACK/NACK bits corresponding to the plurality of DL transport blocks, and transmitting the ACK/NACK payload through a UL channel.

When a priority of a cell is high, a corresponding ACK/NACK bit may be assigned to a most significant bit (MSB) of the ACK/NACK payload.

An ACK/NACK bit corresponding to a DL transport block of the primary cell may have a highest priority.

In another aspect, an apparatus for transmitting an ACK/NACK in a wireless communication system includes a radio frequency (RF) unit configured to transmit and receive a radio signal, and a processor operatively coupled to the RF unit. The processor is configured to configuring a first cell group and a second cell group, wherein the first cell group comprises a primary cell capable of transmitting an uplink (UL) control channel and the second cell group comprises a secondary cell capable of transmitting the UL control channel, receive a plurality of downlink (DL) transport blocks from a plurality of cells belonging to the first cell group and the second cell group, generate an ACK/NACK payload according to a priority of a corresponding cell among a plurality of ACK/NACK bits corresponding to the plurality of DL transport blocks, and transmit the ACK/NACK payload through a UL channel

In an environment where a plurality of cells are configured, an uplink transmission error can be decreased, and a low peak-to-average power ratio (PAPR) can be maintained.

### BRIEF DESCRIPTION OF THE DRAWINGS

FIG. 1 shows various examples of a scenario in which a plurality of cells are configured.

FIG. 2 shows ACK/NACK transmission according to an embodiment of the present invention.

FIG. 3 shows CSI transmission according to another embodiment of the present invention.

FIG. 4 is a block diagram showing a wireless communication system for which an embodiment of the present invention is implemented.

### DESCRIPTION OF EXEMPLARY EMBODIMENTS

A wireless device may be fixed or mobile, and may be referred to as another terminology, such as a user equipment (UE), a mobile station (MS), a mobile terminal (MT), a user terminal (UT), a subscriber station (SS), a personal digital assistant (PDA), a wireless modem, a handheld device, etc. Alternatively, the wireless device may be a device supporting a data communication such as a machine-type communication (MTC) device.

A base station (BS) is generally a fixed station that communicates with the wireless device, and may be referred to as another terminology, such as an evolved-NodeB (eNB), a base transceiver system (BTS), an access point, etc.

It is described hereinafter that the present invention is applied based on 3rd generation partnership project (3GPP) long term evolution (LTE) based on 3GPP Technical Specification (TS). This is for exemplary purposes only, and the present invention is also applicable to various wireless communication systems.

A subframe is a unit for scheduling in 3GPP LTE. For example, one subframe may have a length of 1 millisecond (ms) which is referred as a transmission time interval (TTI). A radio frame includes 10 subframes and one subframe includes 2 consecutive slots. A subframe may include a plurality of orthogonal frequency division multiplexing (OFDM) symbols. Since the 3GPP LTE uses orthogonal frequency division multiple access (OFDMA) in a downlink (DL), the OFDM symbol is only for expressing one symbol period in the time domain, and there is no limitation in a multiple access scheme or terminologies. For example, the OFDM symbol may also be referred to as another terminology such as a single carrier frequency division multiple access (SC-FDMA) symbol, a symbol period, etc. According to 3GPP LTE, in case of a normal cyclic prefix (CP), one subframe includes 14 OFDM symbols, and in case of an extended CP, one subframe includes 12 OFDM symbols.

Physical channels of 3GPP LTE may be classified into a DL physical channels and UL physical channels. The DL physical channels include a physical downlink control channel (PDCCH), a physical control format indicator channel (PCFICH), a physical hybrid-ARQ indicator channel (PHICH) and a physical downlink shared channel (PDSCH). The UL physical channels include a physical uplink control channel (PUCCH) and a physical uplink shared channel (PUSCH).

The PCFICH transmitted in a 1st OFDM symbol of the subframe carries a control format indicator (CFI) regarding the number of OFDM symbols (i.e., a size of the control region) used for transmission of control channels in the subframe. The UE first receives the CFI on the PCFICH, and thereafter monitors the PDCCH.

The PHICH carries a positive-acknowledgement (ACK)/negative-acknowledgement (NACK) signal for an uplink hybrid automatic repeat request (HARQ). The ACK/NACK signal for uplink (UL) data on a PUSCH transmitted by the UE is transmitted on the PHICH.

Control information transmitted through the PDCCH is referred to as downlink control information (DCI). The DCI may include resource allocation of the PDSCH (this is referred to as a DL grant), resource allocation of a PUSCH (this is referred to as a UL grant), a set of transmit power control commands for individual UEs in any UE group, and/or activation of a voice over Internet protocol (VoIP).

PUCCH caries uplink control information (UCI) and supports multiple formats. A

PUCCH having different bits per subframe can be used according to modulation scheme depending on a PUCCH format. PUCCH format 1 carries a scheduling request (SR), PUCCH format 1a/1b carries ACK/NACK for HARQ, PUCCH format 2 carries a CQI and PUCCH format 2a/2a carries CQI and ACK/NACK.

A wireless device may be served by a plurality of serving cells in a carrier aggregation (CA) environment or a dual connectivity environment. Each serving cell may be defined by a downlink (DL) component carrier (CC) or a pair of a DL CC and an uplink (UL) CC.

A serving cell may be classified into a primary cell and a secondary cell. The primary cell operates at a primary frequency, and performs an initial connection establishment procedure or initiates a connection reestablishment procedure, or is a cell designated as a primary cell during a handover. The primary cell may be referred to as a reference cell. The secondary cell operates at a secondary frequency and is configured after establishing a radio resource control (RRC) connection. The secondary cell is used to provide additional radio resources. At least one primary cell is always configured but the secondary cell may be added/modified/released by upper layer signaling (e.g. RRC message). A cell index (CI) of the primary cell may be fixed. For example, a lowest CI may be set as the CI of the primary cell. Hereinafter, the CI of the primary cell is set to zero, and the CI of a secondary cell may be assigned subsequently starting from one.

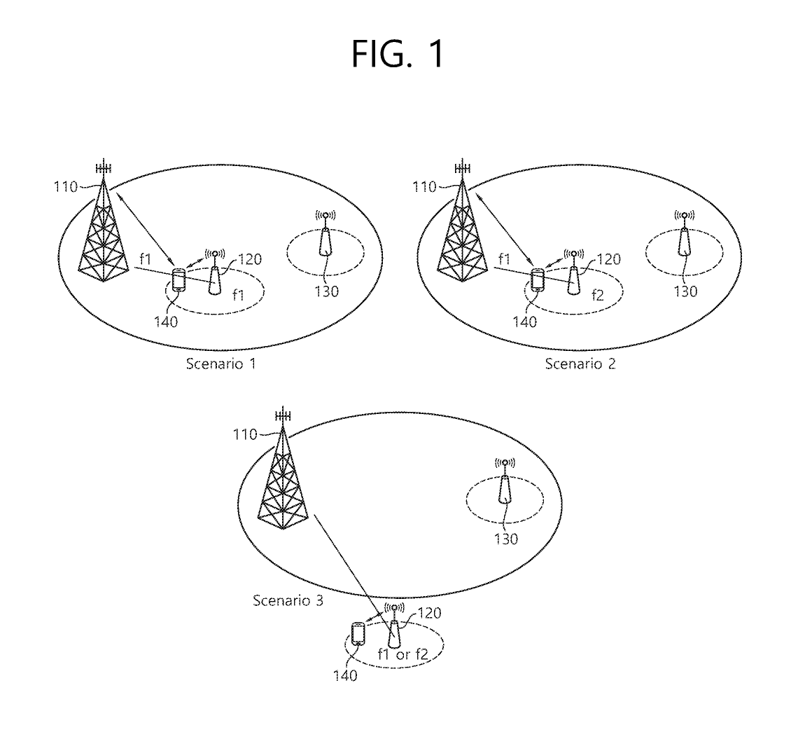

FIG. 1 shows various examples of a scenario in which a plurality of cells are configured.

It is assumed that a 1st BS 110 is a macro BS having wide coverage, and 2nd and 3rd BSs 120 and 130 are small BSs having relatively small coverage. A cell operated by the macro BS 110 is called a macro cell, and a cell operated by the small cells 120 and 130 is called a small cell. Each BSs 110, 120, and 130 may operate one or more cells.

A scenario 1 is a case where the macro BS 110 and the small BSs 120 and 130 communicate with a wireless device 140 by using the same frequency band. A scenario 2 is a case where the macro BS 110 and the small BSs 120 and 130 communicate with the wireless device 140 by using different frequency bands. A scenario 3 is a case where the small BS 120 is out of coverage of the macro BS 110 and communicates with the wireless device 140 by using the same or different frequency bands.

In a dual connectivity, a master cell group (MCG) and a secondary cell group (SCG) may be configured to the wireless device. The MCG is a group of serving cells having a primary cell (PCell) and zero or more secondary cells (SCells). The MCG may be served by the macro BS 110, and the SCG may be served by one or more small BSs 120 and 130. The SCG is a group of secondary cells having a primary secondary cell (PSCell) and zero or more secondary cells. The MCG cell is a cell belonging to the MCG, and the SCG cell is a cell belonging to the SCG. The PSCell is a secondary cell on which the wireless device performs a random access, and is a cell to which an uplink control channel (e.g., a physical uplink control channel (PUCCH)) can be transmitted.

Meanwhile, in order to prevent PUCCH traffic from being concentrated on a specific cell in a network, even if a dual connectivity is not supported, PUCCH offloading can be supported in a CA situation. It may be configured such that a plurality of serving cells configured to a wireless device are divided into a plurality of cell groups, and at least one cell transmits a PUCCH for each cell group.

Hereinafter, a cell group including a PCell is called a 1^{st} cell group, and a cell group including at least one secondary cell is called a 2^{nd} cell group. A cell capable of performing PUCCH transmission in the 1^{st} cell group is called a PCell (or a 1^{st} PUCCH cell), and a cell capable of performing PUCCH transmission in the 2^{nd} cell group is called a PSCell (or a 2^{nd} PUCCH cell). The PCell and the PSCell may independently transmit a UL channel. The PCell may send a message for designating the PSCell among cells in the 2^{nd} cell group.

First, PUCCH-PUSCH simultaneous transmission will be described.

In 3GPP LTE, a wireless device can operate when PUCCH transmission and PUSCH transmission overlap in one subframe. If PUCCH-PUSCH simultaneous transmission is not configured, UCI (ACK/NACK CSI) to be transmitted on a PUCCH is transmitted on a PUSCH in a piggyback manner. When the UCI is transmitted as a part of PUSCH data, it is called ‘piggyback’. If the PUCCH-PUSCH simultaneous transmission is configured, the wireless device may independently transmit the PUSCH and the PUCCH in one subframe.

Simultaneous transmission of the PUCCH and the PUSCH may be allowed between different cells or different cell groups if the PUCCH-PUSCH simultaneous transmission is not activated for a wireless device to which PUCCH offloading is configured, or irrespective of whether the PUCCH-PUSCH simultaneous transmission is configured. Further, the wireless device may simultaneously transmit the PUCCH and the PUSCH in the same cell among cells belonging to a band in which simultaneous transmission is possible.

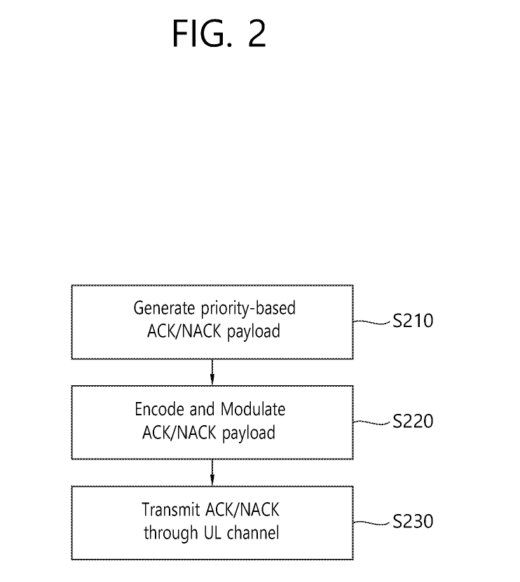

FIG. 2 shows ACK/NACK transmission according to an embodiment of the present invention.

In step S210, a wireless device generates an ACK/NACK payload according to a priority. Upon receiving a plurality of DL transport blocks from a plurality of cell groups, the wireless device may generate an ACK/NACK payload for the plurality of transport blocks.

In a first embodiment, if it is assumed that a PUSCH/PUCCH is transmitted for each cell group, a 1^{st} ACK/NACK payload may be formed for a 1^{st} cell group, and a 2^{nd} ACK/NACK payload may be formed for a 2^{nd} cell group. In each ACK/NACK payload, a highest priority may be given to ACK/NACK of a cell in which PUCCH transmission is possible. An ACK/NACK bit of a cell having a highest priority may be arranged to a most significant bit (MSB). For example, when a 2-bit ACK/NACK is used and the 1^{st} ACK/NACK payload is equal to {A0, A1, A2, A3}, if A0 is an MSB and A3 is a least significant bit (LSB), A0 and A1 may be an ACK/NACK bit of a PCell in the 1^{st} cell group, and A2 and A3 may be an ACK/NACK bit of an SCell in the 1^{st} cell group. When a 2-bit ACK/NACK is used and the 2^{nd} ACK/NACK payload is equal to {B0, B1, B2, B3}, if B0 is an MSB, B0 and B1 may be an ACK/NACK bit in a PSCell in the 2^{nd} cell group, and B2 and B3 may be an ACK/NACK bit in an SCell of the 2^{nd} cell group.

In a second embodiment, if it is assumed that a single PSUCH is transmitted for all cell groups, a single ACK/NACK payload may be formed for 1^{st} and 2^{nd} cell groups. In the single ACK/NACK payload, a highest priority may be given to ACK/NACK of a cell capable of performing PUCCH transmission. If there are a plurality of PUCCH cells, a higher priority may be given to a PCell. Alternatively, in the single ACK/NACK payload, ACK/NACK of a cell group in which the PCell is included may have a higher priority than ACK/NACK of another cell group.

In an embodiment to be proposed, a priority is assigned to HARQ ACK/NACK according to whether a cell is capable of performing PUCCH transmission. ACK/NACK of a cell having a higher priority may be allowed to have the best decoding performance Further, even if an ACK/NACK payload size is changed according to a cell in which a PDSCH is scheduled, an ACK/NACK location of a PUCCH cell is not changed, and thus reliable ACK/NACK transmission can be maintained for the PUCCH cell.

The prioritization is also applicable to prioritization for transmit power of each ACK/NACK information in a situation where transmit power of the wireless device is limited.

In step S220, the wireless device generates an ACK/NACK symbol by encoding and/or modulating the generated ACK/NACK payload.

In step S230, the wireless device transmits the generated ACK/NACK symbol through the PUCCH or the PUSCH.

In 3GPP LTE, an ACK/NACK transmission method using a PUCCH includes ACK/NACK channel selection, ACK/NACK bundling, a PUCCH format 3, etc. If the ACK/NACK transmission method is configured independently for each cell group, a resource required for ACK/NACK transmission must be designated for each cell group, and if ACK/NACK for a plurality of cell groups is piggybacked on a single PUSCH, ACK/NACK of a different format must be combined. As such, a complexity may be increased. Accordingly, if PUCCH offloading is configured, the ACK/NACK transmission method for a plurality of cell groups may be configured identically.

In 3GPP LTE, a resource of a PUCCH for ACK/NACK is related to a PDCCH resource indicating a PDSCH corresponding to the ACK/NACK. That is, upon detecting a PDCCH in a subframe n, the wireless device receives a DL transport block on a PDSCH scheduled by the PDCCH in the subframe n. In addition, the wireless device transmits ACK/NACK for the DL transport block on the PUCCH in a subframe n+4. The resource of the PUCCH is acquired from a resource of the PDCCH.

In PUCCH offloading, cross-carrier scheduling indicated by a PDCCH of a different cell may be configured to a PDSCH of a PSCell. In this case, a resource of a PUCCH transmitted in the PSCell may not be easily acquired from the PDCCH resource of the different cell. If the PDSCH of the PSCell is scheduled by the PDCCH of the PSCell, the PUCCH resource of the PSCell may be allocated in advance through RRC signaling. If the PDSCH is scheduled by the PDCCH of the different cell only for the PSCell in a cell group, a PUCCH resource for a PUCCH format 1/1b may be configured in advance. Even if the PUCCH format 3 is configured in advance by using the ACK/NACK transmission method for the cell group, in case of the PDSCH scheduled only for the PSCell, ACK/NACK may be transmitted through the PUCCH format 1a/1b, thereby increasing efficiency of an ACK/NACK resource.

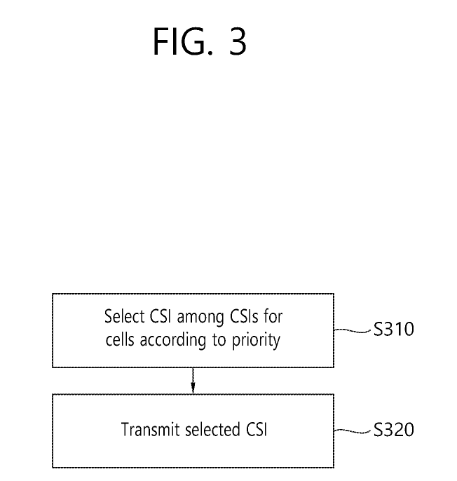

FIG. 3 shows CSI transmission according to another embodiment of the present invention.

Transmission of a plurality of CSIs for a plurality of cells may be triggered in one subframe. In PUCCH offloading, the CSI may be transmitted periodically through a PUCCH for each of the plurality of cell groups. However, when the plurality of CSIs for the plurality of cells are transmitted on one PUCCH or PUSCH, there may be a case in which only a CSI for one cell is transmitted, and the remaining CSIs are dropped.

In step S310, the wireless device selects a CSI to be transmitted according to a priority among a plurality of CSIs for a plurality of cells (or a plurality of cell groups).

In step S320, the wireless device transmits the selected CSI on the PUCCH or the PUSCH. Transmission of a non-selected CSI may be dropped.

A CSI of a PCell may have a higher priority than a CSI of an SPCell. Alternatively, a CSI of a cell belonging to a cell group may have a higher priority than a CSI belonging to a different cell group. This implies that the CSI belonging to the cell of the PCell is preferentially transmitted between the CSI of the cell belonging to the cell group of the PCell and the CSI of the cell belonging to the cell group of the SPCell.

In the cell group, the CSI of the PUCCH cell may have a higher priority than a CSI of a different cell. For example, in a 2^{nd} cell group, the CSI of the SPCell is transmitted preferentially over the CSI of the different cell.

If the CSI is piggybacked on the PUSCH in a cell group to which a cell for transmitting a corresponding CSI belongs, a CSI of a cell capable of transmitting the PUCCH in a corresponding cell group may be transmitted preferentially also over a CSI of a different cell.

The CSI prioritization is applicable to prioritization for a case where the CSI is piggybacked on the PUSCH or prioritization for a case where the CSI is transmitted on the PUCCH.

Further, the CSI prioritization is also applicable to prioritization for CSI bit arrangement in a payload to be piggybacked on the PUSCH or transmitted on the PUCCH.

The prioritization is also applicable to prioritization for transmit power of the CSI in a situation where transmit power of the wireless device is limited.

Now, a UCI piggyback priority will be described.

Assume that a piggyback of UCI (ACK/NACK, CSI, etc.) for a PUSCH is achieved only in a cell group. If PUSCH transmission for a plurality of cells is scheduled in the cell group, the UCI may be piggybacked on the PUSCH transmitted through a PSCell capable of transmitting the PUSCCH preferentially in a cell group consisting of only an SCell.

Assume that the UCI can be piggybacked on the PUSCH transmitted in any cell without a distinction of a cell group. A cell on which the UCI is piggybacked may be selected in order of a PCell, a PSCell, and other SCells.

A PUSCH transmitted through a specific cell group (e.g., a cell group to which the

PCell belongs or a cell group belonging to a licensed band) may have a higher UCI piggyback priority than a PUSCH transmitted through another cell group (e.g., a cell group to which the PCell does not belong or a cell group belonging to an unlicensed band).

Now, simultaneous transmission of a sounding reference signal (SRS) and a PUCCH/PUSCH will be described.

In 3GPP LTE, if transmission of the SRS and the PUCCH/PUSCH is triggered for different cells in one subframe, the SRS is not transmitted but dropped. This is to decrease UL transmission complexity of a wireless device, and to decrease a UL peak-to-average power ratio (PAPR).

A wireless device having PUCCH offloading capability is basically capable of transmitting a plurality of PUCCHs for different cells in one subframe, and thus may not have a problem in simultaneous transmission of the SRS and the PUCCH/PUSCH. Accordingly, the following is proposed to increase SRS transmission efficiency.

First, a wireless device to which PUCCH offloading is configured or which has the PUCCH offloading capability may transmit the SRS and the PUCCH/PUSCH for different cells in one subframe. Simultaneous transmission of the SRS and the PUCCH/PUSCH may be possible only for simultaneous transmission for cells belonging to different cell groups.

Second, the PUCCH offloading may be allowed only between different timing advance groups (TAGs). The TAG is a cell group to which the same TA is applied. The 1^{st} cell group may be a 1^{st} TAG, and the 2^{nd} cell group may be a 2^{nd} TAG. Alternatively, the PUCCH offloading may be configured only when a plurality of TAGs are configured to the wireless device.

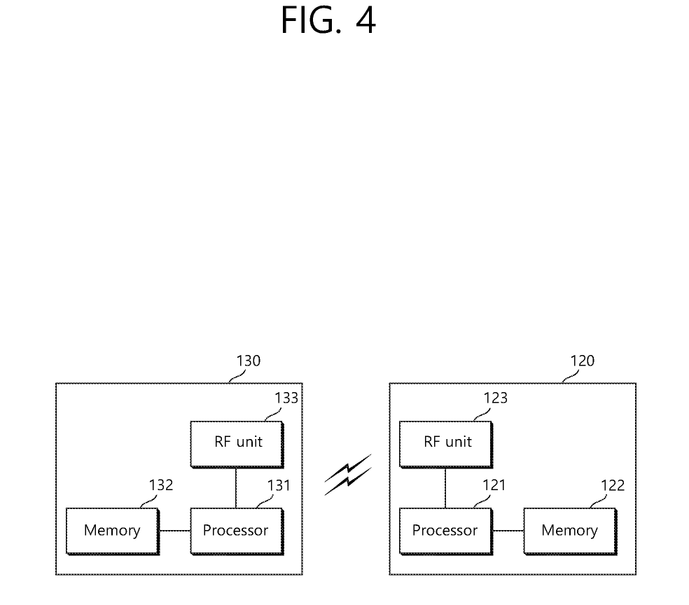

FIG. 4 is a block diagram showing a wireless communication system for which an embodiment of the present invention is implemented.

A wireless device 50 includes a processor 51, a memory 52, and a transceiver 53. The memory 52 is coupled to the processor 51, and stores various instructions executed by the processor 51. The transceiver 53 is coupled to the processor 51, and transmits and/or receives a radio signal. The processor 51 implements the proposed functions, procedures, and/or methods. In the aforementioned embodiment, an operation of the wireless device may be implemented by the processor 51. When the aforementioned embodiment is implemented with a software instruction, the instruction may be stored in the memory 52, and may be executed by the processor 51 to perform the aforementioned operation.

ABS 60 includes a processor 61, a memory 62, and a transceiver 63. The BS 60 may correspond to a primary cell or a secondary cell. Alternatively, the BS 60 may correspond to a cell for transmitting a CRS/DRS. The memory 62 is coupled to the processor 61, and stores various instructions executed by the processor 61. The transceiver 63 is coupled to the processor 61, and transmits and/or receives a radio signal. The processor 61 implements the proposed functions, procedures, and/or methods. In the aforementioned embodiment, an operation of each cell may be implemented by the processor 61.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for transmitting an ACK/NACK in a wireless communication system, the method comprising:
configuring a first cell group and a second cell group, wherein the first cell group comprises a primary cell capable of transmitting an uplink (UL) control channel and the second cell group comprises a secondary cell capable of transmitting the UL control channel;
receiving a plurality of downlink (DL) transport blocks from a plurality of cells belonging to the first cell group and the second cell group;
generating an ACK/NACK payload according to a priority of a corresponding cell among a plurality of ACK/NACK bits corresponding to the plurality of DL transport blocks; and
transmitting the ACK/NACK payload through a UL channel

2. The method of claim 1, wherein when a priority of a cell is high, a corresponding ACK/NACK bit is assigned to a most significant bit (MSB) of the ACK/NACK payload.

3. The method of claim 1, wherein an ACK/NACK bit corresponding to a DL transport block of the primary cell has a highest priority.

4. The method of claim 1, wherein the ACK/NACK payload comprises a first ACK/NACK payload generated from an ACK/NACK bit of a cell belonging to the first cell group and a second ACK/NACK payload generated form an ACK/NACK bit of a cell belonging to the second cell group.

5. The method of claim 4, wherein the UL channel comprises a first UL channel on which the first ACK/NACK payload is transmitted and a second UL channel on which the second ACK/NACK payload is transmitted.

6. The method of claim 1, wherein the ACK/NACK payload is generated from ACK/NACK bits of all cells belonging to the first and second cell groups.

7. The method of claim 6, wherein the UL channel comprises one physical uplink control channel (PUCCH) or one physical uplink shared channel (PUSCH) on which the ACK/NACK payload is transmitted.

8. The method of claim 6, wherein an ACK/NACK bit corresponding to a DL transport block of the primary cell has a highest priority among the ACK/NACK bits of all cells.

9. The method of claim 8, wherein an ACK/NACK bit corresponding to a DL transport block of the secondary cell has a next priority among the ACK/NACK bits of all cells.

10. An apparatus for transmitting an ACK/NACK in a wireless communication system, the apparatus comprising:
a radio frequency (RF) unit configured to transmit and receive a radio signal; and
a processor operatively coupled to the RF unit and configured to:
configuring a first cell group and a second cell group, wherein the first cell group comprises a primary cell capable of transmitting an uplink (UL) control channel and the second cell group comprises a secondary cell capable of transmitting the UL control channel;
receiving a plurality of downlink (DL) transport blocks from a plurality of cells belonging to the first cell group and the second cell group;
generating an ACK/NACK payload according to a priority of a corresponding cell among a plurality of ACK/NACK bits corresponding to the plurality of DL transport blocks; and
transmitting the ACK/NACK payload through a UL channel

11. The apparatus of claim 10, wherein when a priority of a cell is high, a corresponding ACK/NACK bit is assigned to a most significant bit (MSB) of the ACK/NACK payload.

12. The apparatus of claim 10, wherein an ACK/NACK bit corresponding to a DL transport block of the primary cell has a highest priority.
